(19) United States
(12) Patent Application Publication
(10) Pub. No.: US 2009/0001067 A1
(43) Pub. Date: Jan. 1, 2009

(54) Cooking Appliance

(75) Inventors: Ingo Bally, Traunstein (DE); Alexander Dinkel, Unterwoessen (DE); Kerstin Feldmann, Bretten (DE); Wolfgang Fuchs, Altenmarkt a.d. Alz (DE); Martin Keller, Traunreut (DE); Edmund Kuttalek, Grassau (DE); Maximilian Neuhauser, Chieming/Egerer (DE); Klemens Roch, Trostberg (DE); Wolfgang Schnell, Trostberg (DE); Guenter Zschau, Traunwalchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 12/087,960

(22) PCT Filed: Jan. 3, 2007
(86) PCT No.: PCT/EP2007/050055

§ 371 Date: Jul. 18, 2008

(30) Foreign Application Priority Data
Jan. 31, 2006 (DE) 10 2006 004 377.4

(51) Int. Cl. F27D 11/00; F24C 3/00

(52) U.S. Cl. 219/392; 126/273 R

(57) ABSTRACT

A cooking appliance, in particular a high-level built-in cooking appliance, including at least one muffle defining a cooking compartment and having a muffle opening, a door for movement into and out of a closed relationship with the muffle opening, a drive device including a drive motor operatively attached to the door for moving the door into and out of a closed relationship with the muffle opening, and a control device in operative communication with the drive device for controlling door movement into and out of a closed relationship with the muffle opening, and a plurality of lift cables operatively attached to the drive device and the door for supporting the door during movement into and out of a closed relationship with the muffle opening.

The present invention relates to a cooking appliance, in particular a high-level built-in cooking appliance, with at least one muffle defining a cooking compartment and having a muffle opening, a door for closing the muffle opening and a drive facility controlled by a control facility for displacing the door, with the drive facility comprising at least one drive motor, which can be used to move ropes connected to the door. The present invention also relates to an associated operating method.

DE 101 64 239 discloses a high-level built-in cooking appliance, with which a drive motor moves a base door by rolling up or letting down traction ropes from a winding drum. The ropes are connected respectively to one side of the base door and are deflected from the drive motor to the base door by way of deflection rollers. The deflection rollers are equipped with switch plates and associated switches, to identify trapping. This can happen for example as a result of time-delayed switching at the two deflection rollers.

A generic high-level built-in cooking appliance is also known for example from DE 101 64 237 and DE 102 28 141.

One disadvantage of the cooking appliances described is that the use of traction ropes with winding drums to drive and deflect the ropes requires a comparatively large amount of space and is also relatively complex to assemble and adjust.

The object of the present invention is to provide a cooking appliance with a drive unit that is more compact and easier to operate.

The present object is achieved by the cooking appliance with the features of claim 1 or 8 and by a method as claimed in claim 20. Advantageous embodiments will emerge individually or in combination from the subclaims in particular.

To this end a cooking appliance, which in particular is a high-level built-in cooking appliance, but which can also be a cooking appliance with an oven carriage, is equipped with ropes, which are in the form of lift cables, which can be moved in a linear fashion by the drive motor.

Lift cables frequently have a steel wire core with wire wound around it; other embodiments are also possible.

In one embodiment of the cooking appliance two lift cables are provided, one side of each of which is secured to one side of the door. The lift cables are hereby guided to a drive wheel of a drive motor through a molding, made of plastic or aluminum for example, with the result that they are coupled to a motor shaft on opposite sides. Rotation of the drive wheel causes the lift cables to be displaced in a linear fashion in an opposing direction, with the door being displaced correspondingly in a linear fashion.

Use of the lift cable drive unit in the cooking appliance firstly has the advantage of a being a structure that takes up less space, since there is no longer any need for the winding drum that is otherwise present on the drive motor. Secondly assembly and adjustment are significantly simpler than for a drive unit with a winding drum, as there is no need for the complex winding onto the winding drum, which for example requires a rope tensioner.

Generally it is possible to use just one or more than two lift cables. Synchronous operation of a number of motors driving lift cables is also possible. The fact that the lift cables are connected to the door generally means that they can be secured to the door directly or to an element connected to the door, e.g. a telescopic rod.

It is advantageous for a compact structure if at least one lift cable is deflected at a support between the drive motor and door, e.g. if in the case of a high-level built-in cooking appliance the drive motor is positioned centrally on a surface of a housing body and the lift cables are deflected out of the motor into vertical, hollow telescopic rods. The supports can be rollers or non-rotatable supports. Rollers have the disadvantage of being comparatively complex to assemble. The lift cables can also slide over a non-rotatable support without being enclosed, but it must then be ensured that the support has adequate abrasion resistance, which can be achieved for example by hardening, surface coating, a high level of hardness of the base material, etc.

It is advantageous for a compact structure and simple assembly, if the drive motor and supports are positioned on the upper surface of a housing body.

To reduce abrasion and to improve operational reliability, it is advantageous, if the lift cables each run at least partially in a guide tube, as they can slide smoothly there.

It is then particularly advantageous, if at least one guide tube for a load-bearing segment of a lifting rope (on which a traction force exerted by the door acts) extends from a guide housing connected to the drive motor up to and including an associated support. This protects the lift cable from external influences in this region and means that it does not slide directly on the support, so that said support does not have to be particularly abrasion resistant. A rotatable support does not furnish any further advantage here compared with the simpler non-rotatable support.

For simpler assembly, low-maintenance operation and to switch a switch by way of the guide tube, it is advantageous if the guide tubes can be deflected under load, as they can then be used as switch levers and can follow a certain non-linear rope movement. The guide tubes can be rigid for example and elastic, for example being coupled in an elastic manner to a guide housing. However the guide tubes are simpler to manufacture if they themselves are not elastically deformable.

In this instance it is particularly advantageous, if at least one support is equipped with a switching device for load measurement. The elastic deformability of the guide tube means that said guide tube is deformed (bent) by the load present on a load-bearing segment of a lift cable in such a manner that it presses on the support as a function of the load. This allows a measured load variable to be measured at the support. Also in the downward trapping instance the elastic energy in the guide tubes can cause the then less loaded ropes to spring back slightly, thereby assisting the switching of a corresponding switch.

Two supports are advantageously thus configured for two sides of the door. The measurable load variable is a function among other things of a load arm of the guide tube. The guide tube can also have more than one supporting element; a load can then be picked off, depending on the structure, at more than one supporting element or for example only at the last supporting element in the direction of the door or at the supporting element that deflects the lift cable to the greatest degree.

It is advantageous for a higher level of operating safety if each switching device is connected to a control circuit, which is set up so that it identifies a trapping instance by evaluating the signals from the switching devices.

The invention can be deployed particularly advantageously in a high-level built-in cooking appliance with a base-level muffle opening and a base door.

The invention is also achieved by means of a generic cooking appliance, wherein at least one load-bearing segment of a rope is deflected at a support between the drive motor and the door and runs in a guide tube at least between the drive motor and including the support. The advantages already described above include a simple but nevertheless material-saving deflection of the ropes and their protection.

It is favorable here too if the at least one guide tube can be deflected, in particular can be elastically deformable, under load and/or wherein at least this support is equipped with a switching device for load measurement. This makes it possible to achieve load measurement with structurally simple means both for lift cables and for other ropes, e.g. traction ropes, regardless of the drive type. There is therefore no need for deflection rollers.

For a compact structure and simple assembly and adjustment it is advantageous if the ropes are lift cables, which can be moved in a linear fashion by the drive motor.

It is then advantageous if at least one guide tube for the load-bearing segment of the at least one lift cable extends from a guide housing connected to the drive motor up to and including the associated support.

The cooking appliance with switching device for load measurement can be operated so that the respective switching device for load measurement is activated after a specific load threshold value has been reached. If only one support is equipped with the switching device, it is possible to conclude that the door is positioned in the opening direction (reduced load on the rope or lift cable) and in the closing direction (increased load on the rope or lift cable). By means of a comparison with the achievement of a target position (e.g. by measuring the position of the door) it is possible to conclude an instance of trapping, if the desired end position on the worktop or the zero position has not yet been reached. The options described in DE 101 64 239 can be used to identify an instance of trapping and to respond to it accordingly.

It is advantageous here if the supports on both sides are respectively equipped with a switching device for load measurement, as it is then possible to detect asymmetrical switching states and use them to identify an instance of trapping.

For simple and economical manufacture it is advantageous if the switching device for load measurement has a switch plate with an associated switch. To identify an instance of trapping in the opening direction of the door it is favorable if the switch plate activates the switch when the load drops below a specific load threshold value. To identify an instance of trapping in the closing direction of the door it is favorable if the switch plate activates the switch when the load exceeds a specific load threshold value.

For more precise load measurement and improved evaluation it may be advantageous if the switching device for load measurement outputs measured load values in steps or without steps. The switching device can hereby comprise a load cell and/or elongation measurement strips for example.

The guide tubes are advantageously secured—directly or indirectly—to the cooking appliance, in particular by means of a guide housing, since it is possible to achieve a reliable support and constant friction conditions thus.

It is then particularly advantageous if the guide housing and/or the drive motor are secured to a yoke of the cooking appliance, as this results in a compact and stable structure. This is particularly favorable, if the guide housing and drive motor are secured to opposite sides of the yoke, e.g. top—bottom and vice versa.

For simple assembly and the option of subsequently adjusting the position of the door in relation to the body, it is advantageous if each rope has a securing element with a longitudinal hole for the passage of a connecting element, in particular a screw, to connect the securing element to the door, on its load-bearing segment. It is thus possible for the longitudinal hole to compensate for any inaccuracy when setting up the drive unit and it is possible to achieve a straight seat and a zero point position by displacing the securing element by means of the longitudinal hole. To this end it is particularly favorable if the longitudinal hole is shorter than 5 cm, in particular if it has a length of 1 cm to 4 cm.

The invention is described in more detail below with reference to the embodiments illustrated in the accompanying figures. The embodiments do not restrict the scope of the invention. In the figures:

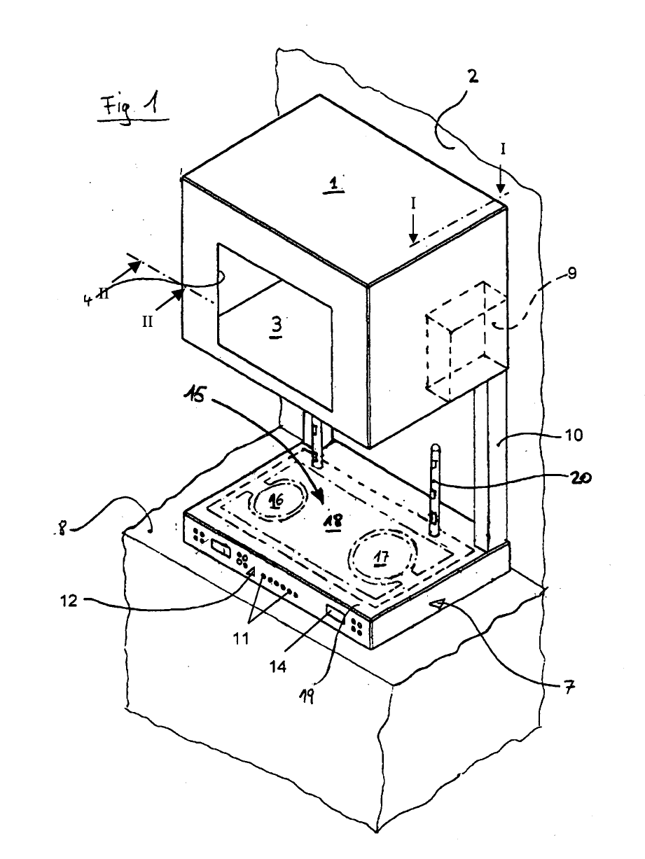

FIG. 1 shows a perspective view of a high-level built-in cooking appliance mounted on a wall with a lowered base door;

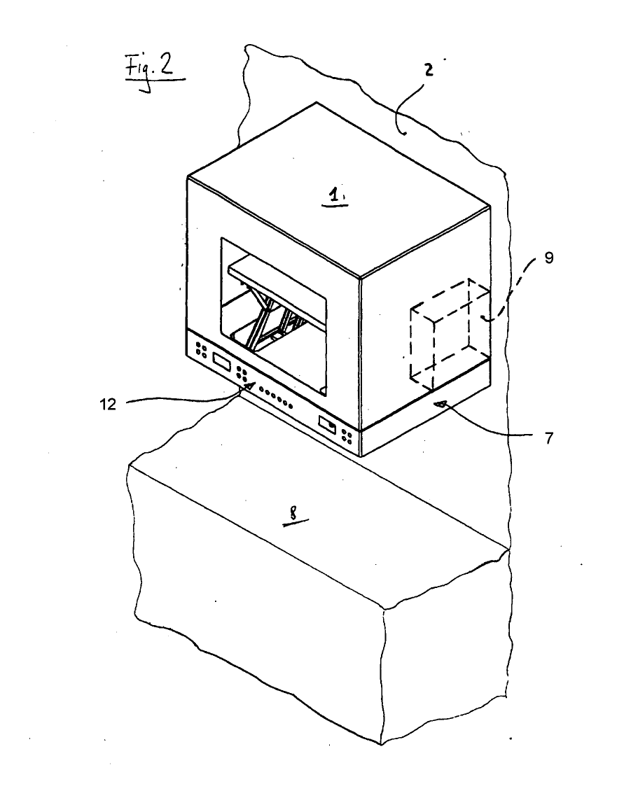

FIG. 2 shows a perspective view of the high-level built-in cooking appliance with the base door closed;

FIG. 3 shows a perspective view of a housing of the high-level built-in cooking appliance without the base door;

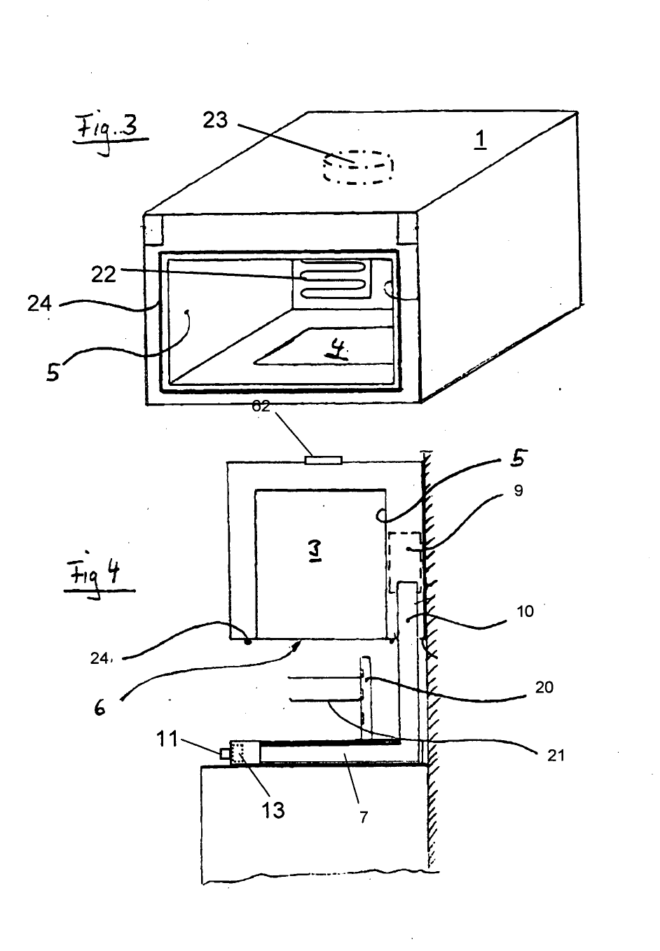

FIG. 4 shows a schematic side view of a sectional representation along the line I-I from FIG. 1 of the high-level built-in cooking appliance mounted on the wall with a lowered base door;

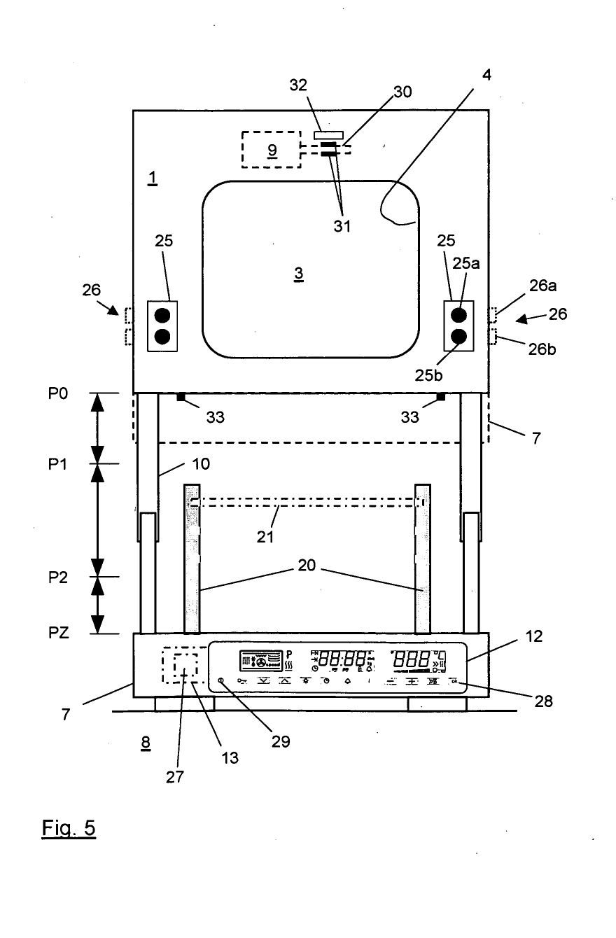

FIG. 5 shows a front view of a further embodiment of a high-level built-in cooking appliance;

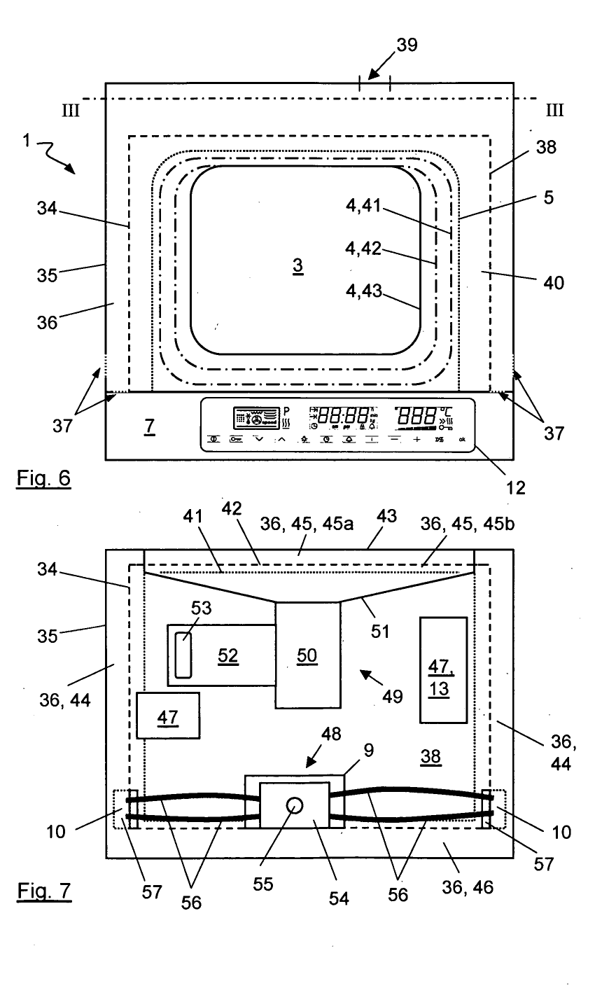

FIG. 6 shows a front view of the embodiment from FIG. 5 in the closed state with a more precise description of the positions of individual housing elements;

FIG. 7 shows a top view of a sectional representation of the embodiment from FIG. 6;

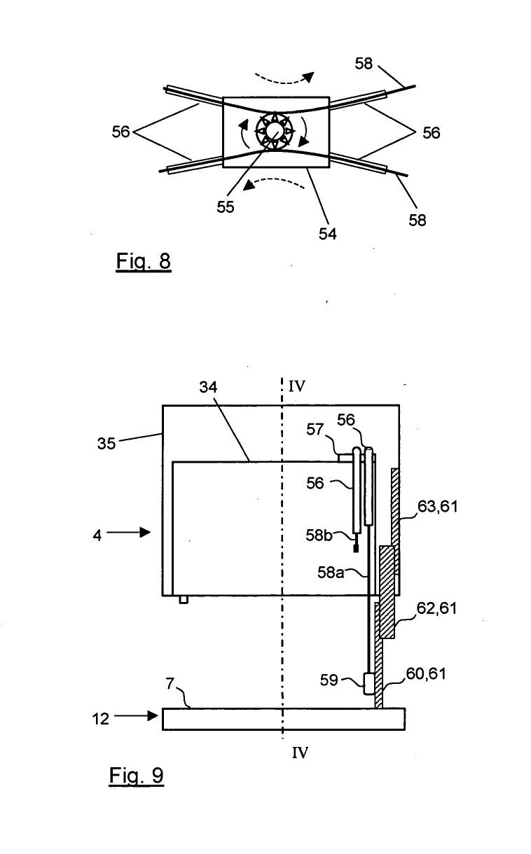

FIG. 8 shows a top view of parts of the drive facility;

FIG. 9 shows a side view as in FIG. 4 of a representation of a further embodiment of the high-level built-in cooking appliance;

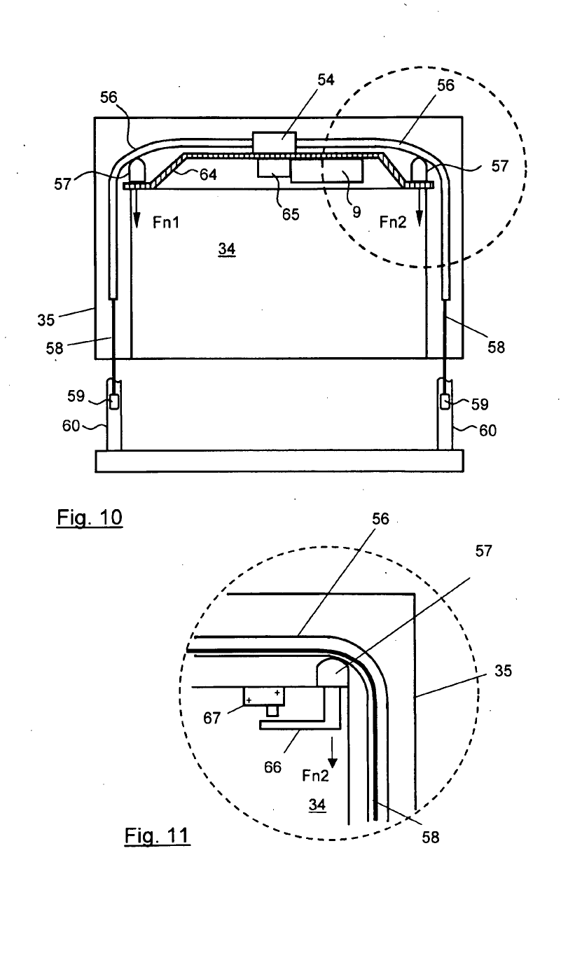

FIG. 10 shows a front view of a sectional representation of selected elements of the embodiment of the cooking appliance according to FIG. 9;

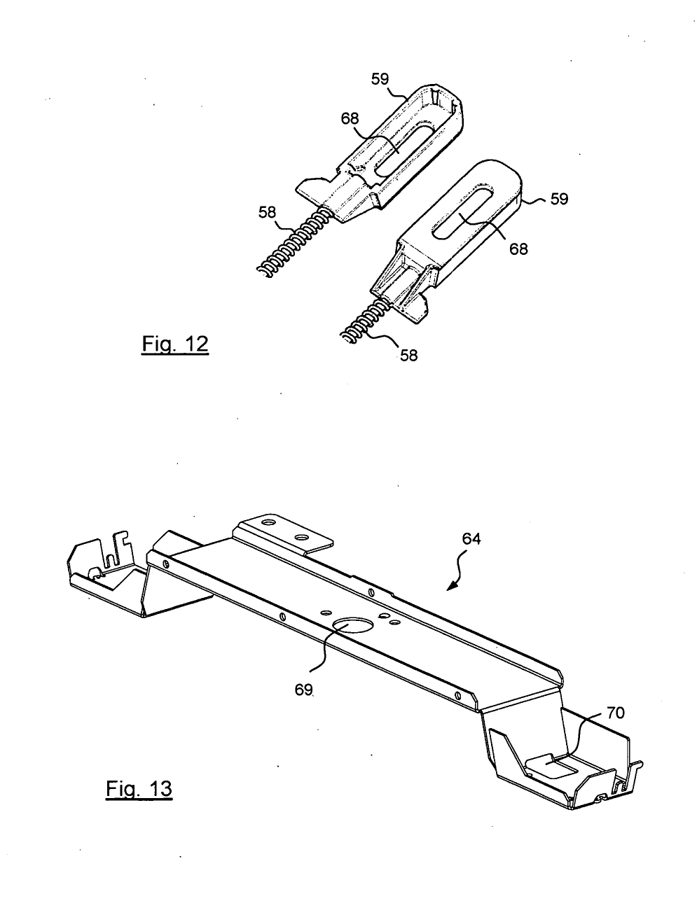

FIG. 11 shows a cut-out from FIG. 10 in more detail;

FIG. 12 shows cut-outs of a lift cable with a securing element;

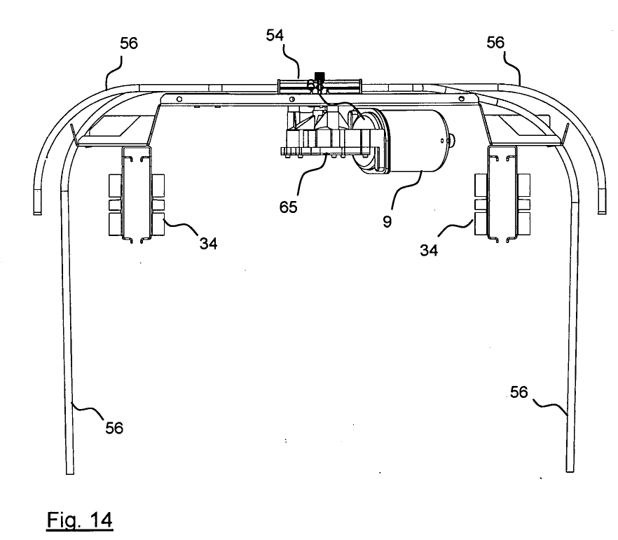

FIG. 13 shows an oblique view from the front down onto a yoke for use in one of the cooking appliances; and

FIG. 14 shows a front view of selected elements of the embodiment of the cooking appliance according to FIG. 10.

To illustrate the individual elements more clearly the figures are not necessarily drawn to scale.

FIG. 1 shows a high-level built-in cooking appliance with a housing 1. The rear face of the housing 1 is mounted on a wall 2 in the manner of a wall cupboard. In the housing 1 a cooking compartment 3 is defined, which can be monitored by way of a viewing window 4 incorporated in the front face of the housing 1. FIG. 4 shows that the cooking compartment 3 is defined by a muffle 5, which is provided with a heat-insulating sheath (not shown), and that the muffle 5 has a base-level muffle opening 6. The muffle opening 6 can be closed with a base door 7. In FIG. 1 the base door 7 is shown lowered, with its underside in contact with a worktop 8 of a kitchen facility. To close the cooking compartment 3 the base door 7 has to be moved into the position shown in FIG. 2, the so-called zero position. To move the base door 7 the high-level built-in cooking appliance has a drive device 9, 10. The drive device 9, 10 has a drive motor 9, shown with a broken line in FIGS. 1, 2 and 4, which is arranged between the muffle 5 and an external wall of the housing 1. The drive motor 9 is arranged in the region of the rear face of the housing 1 and is actively connected, as shown in FIG. 1 or 4, to a pair of lifting elements 10, which are connected to the base door 7. According to the schematic side view from FIG. 4 each lifting element is embodied as an L-shaped carrier, whose vertical arm extends from the drive motor 9 on the housing side. The drive motor 9 can be actuated with the aid of a control panel 12 and a control circuit 13 to move the base door 7, said control panel 12 being arranged on the front face of the base door 7 according to FIGS. 1 and 2. As shown in FIG. 4 the control circuit 13 is located behind the control panel 12 within the base door 7. The control circuit 13, here made up of a number of spatially and functionally separate printed circuit boards that communicate by way of a communication bus, represents a central control unit for the appliance operation and controls and/or regulates for example a heating operation, displacement of the base door 3, implementation of user input, illumination, anti-trapping protection, a clock pulse for the heating element 16, 17, 18, 22 and much more.

It can be seen from FIG. 1 that an upper face of the base door 7 has a hob 15. Almost the entire surface of the hob 15 is taken up by heating elements 16, 17, 18, shown with a dot-dash line in FIG. 1. In FIG. 1 the heating elements 16, 17 are two hotplate heating elements of different sizes at a distance from each other, while the heating element 18 is a surface heating element between the two hotplate heating elements 16, 17, which almost encloses the hotplate heating elements 16, 17. The hotplate heating elements 16, 17 define cooking zones or hotplates for the user; the hotplate heating elements 16, 17 together with the surface heating element 18 define a bottom heating zone. The zones can be indicated by appropriate decoration on the surface. The heating elements 16, 17, 18 can be activated respectively by way of the control circuit 13.

In the exemplary embodiment shown the heating elements 16, 17, 18 are embodied as radiant heating elements, which are covered by a glass ceramic plate 19. The glass ceramic plate 19 has approximately the dimensions of the upper face of the base door 7. The glass ceramic plate 19 is also equipped with assembly openings (not shown), through which bases for holding holder elements 20 for food supports 21 project, as also shown in FIG. 4. Instead of a glass ceramic plate 19 other—preferably fast-response—covers can also be used, e.g. a thin metal sheet.

A control knob provided in the control panel 12 can be used to switch the high-level built-in cooking appliance to hotplate or bottom heating mode, as described below.

In hotplate mode the hotplate heating elements 16, 17 can be activated individually by means of operating elements 11, provided in the control panel 12, by way of the control circuit 13, while the surface heating element 18 remains out of operation. Hotplate mode can be implemented with the base door 7 lowered, as shown in FIG. 1. It can however also be operated with the cooking compartment 3 closed with the base door 7 raised in an energy-saving function.

In bottom heating mode the control facility 13 activates the surface heating element 18 as well as the hotplate heating elements 16, 17.

FIG. 3 shows a schematic diagram of the position of a recirculated air pot 23 with a recirculated air motor and an assigned annular heating element, e.g. to generate hot recirculated air during hot-air operation. The recirculated air pot 23, which is open to the cooking compartment 3, is separated from this typically by a reflector plate (not shown). A top heating element 22 positioned on an upper face of the muffle 5 is also provided and this can have a single ring or a number of rings, e.g. an inner and outer ring. The control circuit 13 can be used to set the various operating modes, such as for example top heating, hot air or rapid heating mode, by corresponding switching on and setting of the heat output of the heating elements 16, 17, 18, 22, in some instances with activation of the fan 23. The heat output can be set by an appropriate clock pulse. The hob 15 can also be designed differently, for example with or without an extended cooking zone, as a purely—single or multi-ring warming zone without hotplates, etc. The housing 1 has a seal 24 toward the base door 7.

The control panel 12 is mainly arranged on the front face of the base door 7. Alternatively other arrangements are also possible, e.g. on the front face of the housing 1, divided between various sub-fields and/or partially on side faces of the cooking appliance. Further embodiments are possible. There is no restriction on the design of the operating elements 11 and they can include for example operating knobs, rocker switches, push buttons and membrane buttons, which comprise display elements 14, e.g. LED, LCD and/or touchscreen displays.

FIG. 5 shows a schematic diagram of a high-level built-in cooking appliance from the front not to scale, wherein the base door 7 is opened and in contact with the worktop 8. The closed state is shown with a broken line.

In this embodiment two displacement switching fields 25 are located on the front face of the permanently mounted housing 1. Each displacement switching field 25 has two push buttons, namely an upper CLOSE push button 25a for a base door 7 moving upward in the closing direction and a lower OPEN push button 25b for a base door 7 moving downward in the opening direction. Without automatic mode (see below) the base door 7 only moves upward where possible as a result of continuous simultaneous pushing of the CLOSE buttons 25a of both displacement switching fields 25; also the base door 7 also only moves downward where possible as a result of continuous simultaneous pushing of the OPEN buttons 25b of both displacement switching fields (manual mode). Since in manual mode the user has to pay more attention to the controls and also both hands are used here, anti-trapping protection is only optional. In an alternative embodiment displacement switching fields 26 are positioned on opposite outer faces of the housing 1 with corresponding CLOSE buttons 26a and OPEN buttons 26b, as shown with a dotted line.

The control circuit 13 shown with a dot-dash line, located in the interior of the base door 7 behind the control panel 12, switches the drive motor 9 in such a manner that the base door 7 starts to move gently, in other words not suddenly by simple activation of the drive motor 9, but by means of a defined ramp.

In this exemplary embodiment the control circuit 13 comprises a storage unit 27 for storing at least one target or displacement position P0, P1, P2, PZ of the base door 7, preferably with volatile memory devices, e.g. DRAMs. If a target position P0, P1, P2, PZ is stored, after actuation of one of the buttons 25a, 25b or 26a, 26b of the displacement switching fields 25 or 26 the base door 7 can move independently in the set direction, until the next target position is reached or one of the buttons 25a, 25b or 26a, 26b is actuated again (automatic mode). In this exemplary embodiment the lowest target position PZ corresponds to maximum opening and the (zero) position P0 to the closed state and P1 and P2 are freely selectable intermediate positions. When the last target position for one direction is reached, it is necessary to move beyond this in manual mode if possible (in other words the last end positions do not correspond to a maximum opened or the closed end state). Similarly if no target position is stored for a direction—as would be the case for example for an upward movement into the closed position, if only PZ is stored but not P0, P1, P2—it is necessary to move in this direction in manual mode. If no target position is stored, e.g. in the case of a new installation or isolation from the power supply, it is not possible to operate in automatic mode. If the base door 7 is displaced in automatic mode, anti-trapping protection is preferably activated.

Automatic mode and manual mode are not mutually exclusive. Continuous actuation of the displacement switching field(s) 25, 26 causes the base door 7 to move in manual mode, even if a target position could be reached in this direction. It is possible here to determine for example a maximum actuation time for the displacement fields 25 or 26 or the associated buttons 25a, 25b or 26a, 26b, to activate automatic mode, e.g. 0.4 seconds.

A target position P0, P1, P2, PZ can be any position of the base door 7 between and including the zero position P0 and the maximum opening position PZ. The maximum stored opening position PZ must not however be the position with contact with the worktop 8. The target position P0, P1, P2, PZ can be stored with the base door 7 in the desired target position P0, P1, P2, PZ by for example multi-second (e.g. lasting two seconds) actuation of an actuation button 28 on the control panel 12. Optical and/or acoustic signal emitters present, which output corresponding signals after a target position has been stored, are not shown for greater clarity. The desired target position P0, P1, P2, PZ to be set is reached for example—in this exemplary embodiment—by operation of the displacement switching fields 25 or 26 with two hands and manual displacement to said position.

Just one or, as shown in this exemplary embodiment, a number of target positions P0, P1, P2, PZ can be stored in the storage unit 27. In the case of a number of target positions P0, P1, P2, PZ, these can then be reached by actuating the corresponding displacement buttons 25a, 25b or 26a, 26b. Having a number of target positions P0, P1, P2, PZ allows the high-level built-in cooking appliance to be adjusted easily to the desired operating level of a number of users. The target position(s) can preferably be deleted and/or overwritten. In one embodiment only one target position in the opened state can be stored, while the zero position P0 is identified automatically and reached automatically. Alternatively the zero position P0 must also be stored so that it can be reached automatically.

It is particularly advantageous for ergonomic use if the or one target position P1, P2, PZ opens the base door 7 at least approximately 400 mm to approximately 540 mm (i.e. P1-P0, P2-P0, PZ-P0≧40 cm to 54 cm). This degree of opening allows the food support 21 to be inserted easily into the holder elements 20. It is favorable here if the viewing window 4 is mounted roughly at the eye level of the user or a little below it, e.g. using a template showing the dimensions of the cooking appliance.

A power failure bypass unit for bypassing an approximately 1 to 3 second power failure, preferably an up to 1.5 second power failure, is not shown.

The drive motor 9 from FIG. 1 has at least one sensor unit 31, 32 on a motor shaft 30, optionally arranged in front of or behind a transmission unit, to measure a displacement path or a position and/or speed of the base door 7. The sensor unit can comprise for example one or more induction, Hall, opto, OFW sensors, etc. For simple path and speed measurement two Hall (sub)elements 31 are arranged here with a 180° offset—in other words opposite each other—on the motor shaft 30 and a Hall measuring sensor 32 is attached at a distance in a fixed position in this region of the motor shaft. If during rotation of the motor shaft 30 a Hall element 31 then passes the measuring sensor 32, a measuring or sensor signal is generated, which is approximately digital. With (not necessarily) two Hall elements 31 two signals are output during one rotation of the motor shaft 30. Temporal evaluation of these signals, e.g. their time difference, allows the speed vL of the base door 7 to be determined, for example by means of comparison tables or conversion to real time in the control circuit 13. It is possible to determine a displacement path or position of the base door 7 by addition or subtraction of the measuring signals.

A speed regulator allows the speed to be realized for example by way of a PWM-controlled power semiconductor.

To determine the zero point the path measurement is automatically compared anew for each approach by initialization in the zero position P0 of the base door 7, in which the base door 7 rests on the muffle 5 in a closing position, so that an incorrect sensor signal output or pick-up for example is not passed on.

The drive motor 9 can be operated by actuating both displacement switching fields 25 and 26 even when the main switch 29 is deactivated.

Instead of two separate switches for each displacement field 25, 26, it is also possible to have a single switch for each displacement field, e.g. a rocker switch with a neutral position, which only switches subject to pressure. Other forms are also possible. Furthermore the type and arrangement of the operating elements 28, 29 of the control panel are also not restricted.

The arrangement and allocation of the control circuit 13 is hereby flexible and not restricted; it can therefore also comprise a number of boards, e.g. a display board, a control board and a lifting board, which are spatially separated.

A for example 4 mm degree of opening can by identified by end switches 33, which deactivate an anti-trapping protection on actuation.

The high-level built-in cooking appliance can also be designed without a storage unit 27, which means that automatic mode is then not possible. This can be expedient in respect of greater operating safety, e.g. as protection against trapping.

FIG. 6 shows a schematic diagram (not to scale) from the front of the position of individual elements of the housing 1 in the closed state, wherein the base door 7 rests in a closing position on the muffle 5, thereby also optically closing the housing 1. The housing 1 consists of an (inner) housing body 34 (shown with a broken line) and a housing cover or panel 35, which encloses the housing body 34 at least to the front and side. The intermediate space 36 between the housing body 34 and housing cover 35 is configured so that cooling air can flow through at least to some extent. To this end lower inward ventilation openings 37, e.g. inward ventilation slots, are provided in the housing cover 35, being positioned lower than the upper surface 38 of the housing body 34, preferably in a region in proximity to the muffle opening or lift base 7. The inward ventilation openings 37 are incorporated here in the underside of the housing cover 35; they can however also be present at the side. There are correspondingly one or more upper ventilation openings 39, e.g. an outward ventilation slot, in the upper part of the housing cover 35, specifically in its top. This allows an air flow of cooling air through the intermediate space 36 to be established, typically from top to bottom, which is then guided away through the top.

The muffle 5 (shown with a dotted line) is incorporated in the housing body 34, with the associated intermediate space 40—apart from the front face—being lined with insulating material. The muffle is configured as a reverse U shape. In order to be able to see into the cooking compartment 3, a number of viewing windows 4 are present, specifically a first (inner) viewing window 41 (shown with a dot-dash line) directly covering the muffle 5, which therefore at least partially represents a wall of the muffle 5, also a second (middle) viewing window (also shown with a dot-dash line) held by the housing body 34 and a third (outer) viewing window 43 in the housing cover 35.

Further intermediate windows can also be included (not shown), which are preferably secured to the housing body 34 or fewer viewing windows 4 can be present, e.g. just the inner and outer viewing windows 41, 43. The ventilation slots 37, 39 can also be incorporated in a different arrangement and form.

FIG. 7 shows a top view of the housing 1 corresponding to the sectional surface III-III from FIG. 6 (also without the upper housing wall) providing a detailed, non-scale view of the housing interior with different elements arranged therein. This view clearly shows the intermediate spaces 36 between the housing body 34 and housing cover 35, specifically the lateral intermediate spaces 44, the front intermediate space 45 and the rear intermediate space 46. Because of the three viewing windows 41, 42, 43 the front intermediate space is divided vertically into a first front intermediate space 45a between the middle viewing window 42 and the outer viewing window 43 and a second front intermediate space 45b between the middle viewing window 42 and the inner viewing window 41. The intermediate spaces do not of course have to be empty but can contain various elements, e.g. lifting elements 10, holders, guides, insulation, air conduction elements, such as air baffles, screws, struts, etc., with not every intermediate space 36 having to permit a significant air flow.

The following in particular are positioned on the housing body 34, for example on a bearing surface above the muffle: electrical or electronic modules 47 such as the control circuit 13, a drive facility 48 and a ventilation facility 49.

The ventilation facility 49 comprises at least one fan, which in this embodiment is just one fan, which takes in air from two directions via two intake openings. To this end a two-part fan is advantageously used, wherein the outlet air is also output at least essentially unmixed. The double radial fan 50 shown here is particularly suitable, having two opposite intake openings and outputting intake air to the side. The two intake air flows are hereby output essentially to the side and parallel to each other.

In the structural form shown here an intake opening of the double radial fan 50 is connected to an intake channel 51, which covers the front intermediate space 45 at least partially from above and as a result takes in cooling air from below from the lower ventilation openings 37 through the front intermediate space 45 during operation. As a result the front intermediate space 45 is cooled for better user safety, having rather less heat insulation due to the viewing windows 4, 41-43.

The other (rear) intake opening of the double radial fan 50 is open. This allows cooling air to be taken in particularly from the lateral intermediate spaces 44 and the rear intermediate space 46 and to flow over the upper surface 38 to the fan 50. This means that it also flows around or through and thus cools the components arranged on the upper surface 38. This is particularly advantageous for the electronic modules 47.

The outlet air of the fan 50 passes through an outlet air channel 52 to an upper air outlet 53, which blows the air out through the air opening(s) 39 from FIG. 6.

The drive facility 48 comprises a motor 9 secured to the center of the surface 38 of the housing body 34, on which motor 9 a guide housing 54 rests. Two guide channels (not shown) run through the guide housing 54. The guide housing 54 has a circular recess for insertion of a pinion 55 of the motor 9. The guide channels pass the recess with open sides so that ropes, cables, etc. in the guide channels engage with the pinion 55. Guide tubes 56 are attached to the outer openings of the guide channels, in other words here to four openings, said guide tubes 56 forming continuous cable channels together with the guide channels. The guide tubes 56 extend in this embodiment from the guide housing 54 to the edge of the upper surface 38 into a region above the lifting elements 10 and beyond the edge downward into the lifting elements 10.

A lift cable runs as a drive cable (not shown) in each of the two cable channels. The lift cable has a pliable metal core with wire wound round it. One end of each lift cable is connected permanently to the base door 7, the other is free. Since both lift cables engage with the pinion 55 on opposite sides, they are displaced in a linear fashion in opposite directions by rotation of the pinion 55.

The guide tubes 56 are elastically deformable, being made of die-cast aluminum for example. At least one load-bearing guide tube 56 (i.e. a guide tube 56 guiding a segment of a lift cable, which is connected permanently—either directly or indirectly—to the base door 7; therefore a load is present on this segment of the lift cable) rests on a support 57, the bearing force being a function of the size of the load on the lift cable. In this embodiment such a support 57 is provided for each guide tube 56 guiding a load-bearing lift cable 58a. The supports 57 are located essentially at the edge of the upper surface 38 of the housing body 34, so that the length—or arm—of the guide tube 56 that can be deflected under load becomes large. This means that the load dependency of the essentially perpendicular force exerted by the respective guide tube 56 on the support 57 is as large as possible. The bearing force is for example a function of the loading on the base door 7 or positioning on a base or an object. By measuring the bearing force it is possible for example to overload the base door 7 or achieve anti-trapping protection.

The length of the guide tubes 56 is at the designer's discretion and can be comparatively short (preferably so, as this is more economical) or in the closed state can reach to the securing point for the lift cable on the base door 7 (preferably so, if cable protection required to securing point for example).

In order to use the support for the lift cable for load measurement, it is advantageous to use guide tubes 56 because of the sliding and abrasion but this is not necessary. It is also possible to guide the lift cables—or cables or ropes generally—freely over suitably positioned (e.g. reaching over the edge of the surface) supports. The supports are then favorably designed in a corresponding manner, e.g. made from a suitable hardened and/or sliding material, surface treated or surface coated.

The guiding of general drive ropes, in particular lift cables, is an independent inventive concept, which allows simple guiding, making it possible to dispense with deflection rollers for example. Alternative drives can also be used, such as those with a winding drum drive; however a linear drive is advantageous due to its greater feed force.

For a more precise description of the drive principle FIG. 8 shows a top view of the guide housing 54 with the guide tubes 56 connected thereto, forming two separate guide channels, in this diagram specifically an upper and a lower guide channel. A lift cable 58, typically around one meter long—runs in each of the guide channels 54, 56. The guide channels direct the lift cables 58 to a recess in the guide housing 54, through which a toothed wheel or pinion 55 driven by the drive motor passes. The teeth of the pinion 55 engage with the winding wire of the respective lift cable 58, which forms a type of linear sequence of teeth from the point of view of the pinion 55.

By rotating the pinion 55 by means of the drive motor—in this instance clockwise as shown by the continuous arrows—the upper lift cable 58 is displaced in a linear fashion from left to right and the lower cable 58 is displaced to the same degree from right to left, as shown by the broken arrows.

Since the lift cables 58 engage continuously with the pinion 55 and are therefore permanently coupled to the drive motor, it is also possible to achieve effective locking of the base door in the opening direction, e.g. to protect against the opening of a hot cooking compartment, for example during pyrolysis, or with the child lock activated. Until now a mechanical locking system was used to lock the door, sealing the door as a function of certain parameters such as a threshold value temperature etc., typically by means of a locking hook. Such a locking system can however be dispensed with, if the drive motor drives the pinion 55 by way of a self-locking transmission unit (not shown) for example according to reference character 9 in FIG. 7. If the drive motor is turned off—which preferably happens as a result of power loss and deactivation of direction switches—a mechanical force and an induction force of the drive motor have to be overcome to open the cooking compartment or generally to move the base door. The force applied to do this has to be even greater, the greater the transmission ratio. For the embodiment illustrated a ratio in the region of 30:1 to 60:1 has proved to be a good compromise between self-locking and displacement speed. A ratio in the region of 40:1 to 50:1, specifically 45:1, is particularly suitable. With a ratio of 45 it was not possible to open the base door with a loading of more than 20 kg.

One preferred embodiment of the transmission unit is a worm gear.

Of course the transmission ratio is not restricted to this range but can be adjusted by the person skilled in the art, for example based on the specifications of the drive motor used, the mechanical friction of the actuation mechanism of the base door, the type of drive (lift cable, winding drum, etc.), the weight and loading of the base door, etc.

The guide tubes 56 are arranged next to each other not on top of each other, in order thus favorably to achieve essentially identical operating and loading conditions (load distribution, bearing forces, friction, etc.) of the guide tubes 56 and/or the lift cables 58.

FIG. 9 shows a side view similar to the one in FIG. 4 of a further embodiment of the high-level built-in cooking appliance with a more precise description of the drive facility from FIGS. 7 and 8. The drive motor 9, the guide housing 54, the ventilation facility 49 and the electronic modules 47 are not shown for greater clarity. The other side of the cooking appliance has a similar structure.

It can be seen that the elastically deformable guide tubes 56 rest on the support at the top and then are bent downward. The lift cables 58 exit from the free openings in the guide tubes 56, specifically a load-bearing (i.e. bearing the base door 7) segment 58a of a lift cable (right), which is connected permanently by way of a securing element 59 to a lower runner 60 of a telescopic bar 61 as the lifting element and thus indirectly to the base door 7. The other (left) lift cable 58 has a free segment 58b on this side. The respectively other lift cable is secured and/or free on the other side of the cooking appliance.

The lower runner 60 can be displaced in a linear fashion on the front face in a first guide bar of a bar housing 62 of the double telescopic rod 61. An upper runner 63 can be displaced in a linear fashion in the same direction in the other guide bar of the bar housing 62, it being possible to pull both runners 60, 62 out to opposite sides (in this instance downward or upward). The upper runner 63 is secured to the appliance body, in particular to a rear support frame.

Actuating the drive motor causes the lift cables 58 to be displaced in a linear fashion as described above and to raise the base floor 7 correspondingly above the lower runner 60 or to lower it. During lifting or approaching the motor contracts the telescopic bars 61 for this purpose.

FIG. 10 shows a front sectional view of the embodiment of the cooking appliance according to FIG. 9, in the sectional plane IV-IV from FIG. 9, with some elements no longer shown for greater clarity. Only sections of the lower runners 60 are therefore shown.

It can be seen that the lift cables 58 and the guide tubes 56 are deflected from the horizontal to the vertical at the support 57. Therefore the respective load-bearing segment of the lift cables 58 exerts a (deflection) force on each of the supports 57 by way of the elastically deformable guide tubes 56, said force being essentially a function of the load on the load-bearing segment of the lift cable 58, including the weight of the base door 7 and its loading.

By measuring the deflection force, in particular the respective normal force at the corresponding support 57, it is possible to identify overloading of the base door 7 or trapping for example. Overloading of the base door 7 can be measured for example by the exceeding of a specific load threshold value.

Trapping in the closing movement direction of the base door 7, in other words generally between the base door 7 and housing 1, and in the opening direction of the base door 7, in other words generally between the base door 7 and worktop, can be identified for example if a difference between Fn1 and Fn2 becomes greater than a specific set threshold value. Alternatively time differences can be detected during load reduction between the two sides.

Since, as described above, the lift cables 56 are preferably arranged next to one another, the motor 9 favorably engages in the guide housing 54 from above or below. To this end a yoke 64 is provided, to the upper side of which the guide housing 54 and therefore also the guide tubes 56 are secured. The yoke 64 is in turn fixed securely to the cooking appliance. The yoke 64 allows the motor 9 to be coupled simply to the guide housing 54 and therefore to the lift cables 58, in that the motor is positioned on the underside of the yoke 64 (in other words the side opposite the guide housing 54) and a drive shaft (not shown) optionally with pinion is guided through the yoke 64. In this embodiment the transmission unit 65 is present between the yoke 64 and the motor 9; this arrangement is particularly space-saving. The yoke 64 therefore allows a particularly compact and stable drive arrangement. The yoke 64 can also hold the supporting elements 57.

FIG. 11 shows a cut-out shown with the broken circle in FIG. 10 in greater detail.

Here the support 57 moves a switch plate 66, which switches a switch 67 when the load is reduced. In this exemplary embodiment it can only be detected that the load is below or above a load threshold value. Possible applications, embodiments and measuring principles are described for this for example in DE 102 28 140 A1 and DE 101 64 239 A1.

Alternatively other load-measuring sensors can measure the forces acting on the support 57, in particular but not solely the normal force Fn. In such instances further evaluation options can be used to detect trapping, for example a change in the speed of the load, which in some instances is above a specific threshold value or deviates from a setpoint value (e.g. a displacement speed or speed gradient) and therefore indicates trapping.

FIG. 12 shows the securing elements 59 from FIGS. 9 and 10 in an oblique view of the front and rear in greater detail. It shows that the securing elements 59 attached to the ends of a lift cable 58 have a longitudinal hole 68. This longitudinal hole is particularly advantageous for the described high-level built-in cooking appliance, because it allows a connection between the cooking appliance body and/or the drive unit attached thereto and the base door to be achieved in a particularly simple and precise manner, in particular when using a lift cable. It is then possible to pre-assemble the drive unit, including the motor, transmission unit, guide housing, guide tubes and lift cables, in particular when the lift cable is inserted. The position of the lift cables in the guide tubes then does not have to be set accurately, since once the drive unit is secured to the appliance, the accuracy of fit of the lift cables and therefore the base door, can be adjusted in relation to the body by means of the longitudinal holes 68. For example it is only necessary to tighten a screw guided through the respective longitudinal hole 68 after the correct position of the securing elements 59 has been set in relation to the base door. In other words the longitudinal hole 68 allows an insertion tolerance of the lift cables in their guide tubes and/or in relation to the pinion corresponding roughly to the length of the longitudinal hole 68 to be compensated for. This means that the cooking appliance is simpler to assemble and it is possible to adjust the position of the base door in relation to the body or muffle at a later stage.

FIG. 13 shows an oblique view from the front down onto the yoke 64 from FIG. 10. In its center the yoke has a guide 69 for connecting the motor or transmission unit to the guide housing and thus to the lift cables. A recess 70 is present at the side in each instance for the passage of securing elements to secure the yoke 64 to the cooking appliance.

FIG. 14 shows a front view of the yoke 64 with the motor 9, transmission unit 65 and guide housing 54 secured thereto. The guide tubes 56 leave the side of the guide housing and are directed downward in a lateral region. The yoke is supported on and secured to the housing body 34 (only shown by a support segment here). This means that the guide tubes 56 are also coupled permanently by way of the guide housing. This results in the illustrated compact arrangement with a high level of stability.

### List of Reference Characters

1 Housing
2 Wall
3 Cooking compartment
4 Viewing window
5 Muffle
6 Muffle opening
7 Base door
8 Worktop
9 Drive motor
10 Lifting element
11 Operating element
12 Control panel
13 Control circuit
14 Display elements
15 Hob
16 Hotplate heating element
17 Hotplate heating element
18 Surface heating element
19 Glass ceramic plate
20 Holder element
21 Food support
22 Top heating element
23 Fan
24 Seal
25 Displacement switching field
25a Displacement switch up
25b Displacement switch down
26 Displacement switching field
26a Displacement switch up
26b Displacement switch down
27 Storage unit
28 Actuation button
29 Main switch
30 Motor shaft
31 Hall element
32 Measuring sensor
33 End switch
34 Housing body
35 Housing cover
36 Intermediate space
37 Lower ventilation openings
38 Upper surface of housing body (34)
39 Upper ventilation opening
40 Intermediate space
41 First (inner) viewing window
42 Second (middle) viewing window
43 Third (outer) viewing window
44 Lateral intermediate spaces
45 Front intermediate space
45a First front intermediate space
45b Second front intermediate space
46 Rear intermediate space
47 Electrical or electronic modules
48 Drive facility
49 Ventilation facility
50 Fan
51 Intake channel
52 Outlet air channel
53 Air outlet
54 Guide housing
55 Toothed wheel
56 Guide tube
57 Support
58 Lift cable
58a Load-bearing segment
58b Free segment
59 Lift cable securing element
60 Lower runner
61 Telescopic bar
62 Bar housing
63 Upper runner
64 Yoke
65 Transmission unit
66 Switch
67 Switch plate
68 Longitudinal hole
69 Yoke guide
70 Yoke securing recess
Fn Normal force
Fn1 Normal force
Fn2 Normal force
P0 Zero position
P1 Intermediate position
P2 Intermediate position
PZ End position

1-24. (canceled)

25. A cooking appliance, in particular a high-level built-in cooking appliance, including at least one muffle defining a cooking compartment and having a muffle opening, a door for movement into and out of a closed relationship with the muffle opening, a drive device including a drive motor operatively attached to the door for moving the door into and out of a closed relationship with the muffle opening, and a control device in operative communication with the drive device for controlling door movement into and out of a closed relationship with the muffle opening, the cooking appliance comprising a plurality of lift cables operatively attached to the drive device and the door for supporting the door during movement into and out of a closed relationship with the muffle opening.

26. The cooking appliance according to claim 25 and further comprising at least one support member disposed between the drive motor and the door for deflecting at least one lift cable.

27. The cooking appliance according to claim 26 wherein the drive motor and the at least one support member are disposed on an upper surface of a housing body.

28. The cooking appliance according to claim 25 and further comprising a plurality of guide tubes for containing the lift cables, with each said guide tube containing a lift cable.

29. The cooking appliance according to claim 28 wherein at least one guide tube for a load-bearing segment of a lift cable extends from a guide housing connected to the drive motor up to and including the associated support member.

30. The cooking appliance according to claim 28 wherein the guide tubes are formed as elastically deflectable members, in particular deformable members.

31. The cooking appliance according to claim 30 and further comprising at least one switching device for load measurement operatively associated with at least one support member.

32. A cooking appliance, in particular a high-level built-in cooking appliance, including at least one muffle defining a cooking compartment and having a muffle opening, a door for movement into and out of a closed relationship with the muffle opening, a drive device including a drive motor operatively attached to the door for moving the door into and out of a closed relationship with the muffle opening, and a control device in operative communication with the drive device for controlling door movement into and out of a closed relationship with the muffle opening, the appliance comprising a plurality of ropes each including a load-bearing segment and each being operatively attached to the drive device and the door for moving the door into and out of a closed relationship with the muffle opening, a support member disposed between the drive motor and the door for deflecting at least one load-bearing segment of a rope and at least one guide tube for containing at least one rope disposed between the drive motor and the support member.

33. The cooking appliance according to claim 32 wherein the at least one guide tube is elastically deflectable, in particular deformable, under load.

34. The cooking appliance according to claim 32 wherein at least one support member includes a switching device for load measurement.

35. The cooking appliance according to claim 32 wherein the ropes are formed as lift cables linearly moveable by the drive motor.

36. The cooking appliance according to claim 35 wherein at least one guide tube for the load-bearing segment of the at least one lift cable extends from a guide housing connected to the drive motor up to and including the associated support member.

37. The cooking appliance according to claim 28 and further comprising at least one guide housing for securing the guide tubes to the cooking appliance.

38. The cooking appliance according to claim 37 wherein at least one of the guide housing and the drive motor are secured to a yoke disposed on the cooking appliance.

39. The cooking appliance according to claim 38 wherein the guide housing and the drive motor are secured to opposite sides of the yoke.

40. The cooking appliance according to claim 31 the at least one switching device is operatively connected to the control device, with the control device being configured to determine a trapping event by evaluating the signals from the at least one switching device.

41. The cooking appliance according to claim 25 wherein each rope includes a securing element formed with an opening therein for passage of a connecting element therethrough, in particular a screw, to connect the securing element to the door, on a load-bearing segment of the rope.

42. The cooking appliance according to claim 41 wherein the opening is formed as a longitudinal hole having a length of about 1 cm to about 4 cm.

43. The cooking appliance according to claim 25 wherein the cooking appliance is a high-level built-in cooking appliance having a base-level muffle opening and a base door.

44. A method for operating a cooking appliance comprising the steps of:
providing a high-level built-in cooking appliance including at least one muffle defining a cooking compartment and having a muffle opening, a door for movement into and out of a closed relationship with the muffle opening, a drive device including a drive motor operatively attached to the door for moving the door into and out of a closed relationship with the muffle opening, and a control device in operative communication with the drive device for controlling door movement into and out of a closed relationship with the muffle opening, a plurality of ropes each including a load-bearing segment wherein each rope is operatively attached to the drive device and the door for moving the door into and out of a closed relationship with the muffle opening, at least one a support member disposed between the drive motor and the door for deflecting at least one load-bearing segment of a rope and at least one guide tube for containing at least one rope disposed between the drive motor and the support member; and at least one switching device operatively associated with the control device and disposed on the at least one support member; and
activating the switching device for load measurement using pressure on the respective support member, wherein the guide tubes are deformed by a load present on respective ropes.

45. The method according to claim 44 wherein the switching device for load measurement is activated after a specific load threshold value has been reached.

46. The method according to claim 45 wherein the switching device for load measurement includes a switch plate and an associated switch, with the switch plate activating the switch when the load drops below a specific load threshold value.

47. The method according to claim 44 wherein the switching device for load measurement emits a output signal based on measured load values in steps or without steps.

48. The method according to claim 47 wherein the switching device for load measurement includes at least one of a load cell and elongation measurement strips.
